(19) United States
(12) Patent Application Publication
(10) Pub. No.: US 2017/0348827 A1
(43) Pub. Date: Dec. 7, 2017

(54) Cleaning Assembly and Method for Tire Curing Mold Having Adjustable Insulation Hood

(71) Applicant: Lang Yuzer Otomotiv Yan Sanayi Ve Ticaret Anonim Sirketi, Cerkezkoy/Tekirdag (TR)

(72) Inventors: Ismet Yuzer, Cerkezkoy/Tekirdag (TR); Okan Denizli, Cerkezkoy/Tekirdag (TR)

(21) Appl. No.: 15/539,562

(22) PCT Filed: Dec. 25, 2015
(86) PCT No.: PCT/TR2015/000387

§ 371 Date: Jun. 23, 2017

(30) Foreign Application Priority Data
Dec. 25, 2014 (TR) 2014/15811

(51) Int. Cl. B24C 3/32; B24C 1/00; B08B 9/00; B25J 19/00; B25J 11/00; B29C 33/72; B29D 30/06; B24C 9/00; B08B 13/00

(52) U.S. Cl. CPC B24C 3/325; B25J 11/00; B24C 1/003; B08B 9/00; B29C 33/72; B25J 19/0075; B24C 9/00; B08B 13/00; B29D 2030/0663

(57) ABSTRACT

Invention is a cleaning assembly for cleaning a tire curing mould comprising a turntable (20) mounted on a base plate (12); a cleaning arm (50) extending on the turntable (20) in a movable manner and configured to blow dry ice, and an insulation hood (60) surrounding the cleaning arm (50) wherein the base plate (12) is having an adapter support (16) configured to be gradually widen or narrow for being adapted to the insulation hoods with different diameters on the base plate.

### TECHNICAL FIELD

Invention relates to a cleaning machine using dry ice to clean tire curing moulds suitable for production of vehicle tires.

### STATE OF THE ART

Two-piece curing molds comprising a top and a bottom part as placed on each other are used in the vehicle tire production wherein one part is movable in a vertical direction to an open position. Vulcanization process is completed in such molds and removal of the clean rubber residues usually at the recesses of mold forming tire treads or other walls of upper halve (segment) and/or sidewalls of up and bottom part of molds.

It is known from the prior art that dry ice is blasted from a nozzle to inner mold volume to be cleaned in order to operate a non-abrasive cleaning process. Operation leads to a high decibel noise above the work safety limits for an operator. A method and device is disclosed by international patent publication WO9807548A1 wherein frozen gas pellets are used to clean vehicle tires by means of a robotically controlled apparatus. Document teaches receiving heated mold in a sound-proof cabin where a robot arm equipped with a nozzle is direct frozen gas pellets to the mold surface to be cleaned. Arm is disposed on a turntable in and rotated in order to clean complete mold surface. After completion of the operation mold is removed from the cabin. Preferable frozen gas is CO2 which access to the micro scaled openings and non-abrasive over the mold. Preferred embodiment requires a carriage assembly in order to transport molds to the sound insulated cabin. Additionally, it is necessary to remove to molds to be cleaned. Both cases increase cost of the production.

International patent application WO0002709A1 discloses a similar embodiment. A dry-ice nozzle is provided at the free end of the support arm in a rotatable manner and integrated with the elongation axis of the support arm. Supply pipe from a dry ice machine is connected to the dry ice nozzle. An adjustment device attached to the support arm ensures adjustment of the dry ice nozzle at an appropriate angle to the rotation axis.

U.S. Pat. No. 6,406,360 discloses a device for cleaning the inner walls of vulcanizing molds by means of a blasting device/nozzle and a manipulating device, with the blasting device and the manipulating device being accommodated and encapsulated in an isolation hood that is provided with an adapter ring, and with the isolation hood being suspended on a movable boom and connectable to the outer circumference of a partial mold by means of the adapter ring.

### BRIEF DESCRIPTION OF THE INVENTION

Object of the invention is easy adaptation of the tire curing mold cleaning assembly to different tire molds.

In order to achieve above objective, invention is a cleaning assembly for cleaning a tire curing mold comprising a turntable mounted on a base plate; a cleaning arm extending on the turntable in a movable manner and configured to blast dry ice, and an insulation hood encapsulating the cleaning arm. In a preferred embodiment of the invention, the base plate is having an adapter support configured to be gradually widen or narrow for being adapted to the insulation hoods with different diameters on the base plate. This allows use of the same cleaning arm on the same turntable to clean a car tire curing mold or a truck tire curing mold.

In a preferred embodiment, inner face of the adapter support is having multiple inner grooves inside one another to hold the insulation hood from one edge from which is inserted into the inner groove. Grooves, provide an mounting portion gradual inside one another and hoods with different dimensions are mounted to the corresponding diameter to secure base plate from the adapter support. Width of the groove is defined by closer to the insulation hood thickness in order to provide a tight fit.

In a preferred embodiment, the inner grooves are in form of coaxial rings. This form provide a compact adapter structure. In an alternative embodiment, the inner grooves are in form of a spiral. This form constitutes a compact structure that provides continuity.

In a possible embodiment, the adapter support is configured to have an inner groove at a vicinity of outer side of the turntable and an outer groove at a vicinity of outer edge of the base plate. This form allow a compact dimension due to the minimum gap between the adaptor support's the turntable outer side and the base plate.

In a preferred embodiment, insulation hood is in a cylindrical form coaxial with the turntable.

Equal distance between the insulation hood and the turntable is provided and sound is insulated equally in each direction.

In a preferred embodiment, the base plate is pivotally connected to a carriage by means of a foldable arm from outer side. Carriage allows mobility to the cleaning assembly. Therefore, fast adaptation of the cleaning assembly by means of easy access to the molds with different dimensions is performed.

In a preferred embodiment, the base plate is a bottom of a cylindrical basket. Basket is easily adaptable for various turntables.

In order to achieve above objective, invention is a cleaning method for a tire mold comprising a cleaning assembly as described above. Preferred application comprising the steps of selection of a insulation hood in accordance with the outer diameter of a tire mold halve; configuration of adapter support to receive outer diameter of the insulation hood then mounting of the insulation hood to the adapter support and cleaning of the mold inside the insulation hood by means of the cleaning arm. The method allow fast operation with single cleaning assembly in a facility with different diameters of tire curing molds.

In a preferred application, steps of selection as sidewall mold as a tire mold halve to be cleaned and disposing an outer edge of the insulation hood inside a gap defined between the sidewall mold and a neighbouring segment mold.

### DESCRIPTION OF THE FIGURES

The additional features and advantages of the invention will emerge example that reference to the accompanying drawings embodiments.

FIG. 1 is a schematic illustration of side view for a vehicle carrying the cleaning apparatus of the invention.

FIG. 2 curing of the inventive cleaning device is a schematic cross sectional side view of the mold sidewalls on the applied state.

FIG. 3 an embodiment of the inventive cleaning apparatus shown in FIG. 2 is the schematic top and side views.

FIG. 4 is side and top schematic representation of a different embodiment of the inventive cleaning device.

### REFERENCE NUMBERS

1 Carriage
2 Foldable arm
3 Hinge
4 Support arm
5 Handle
6 Joint
10 Basket
11 Outer edge
12 Carrier plate
13 Central region
16 Adapter support
17 Intermediate groove
18 Inner groove
19 External groove
20 Turntable
30 Platform
40 Pivot
50 Cleaning arm
60 Insulation hood
62 Lateral wall
64 Outer edge
66 Inner edge
70 Segment mould
72 Bottom edge
80 Sidewall mold
82 Frontal surface
84 Radial outer edge
86 Opening
88 Outer edge
90 Bladder

### DETAILED DESCRIPTION OF THE INVENTION

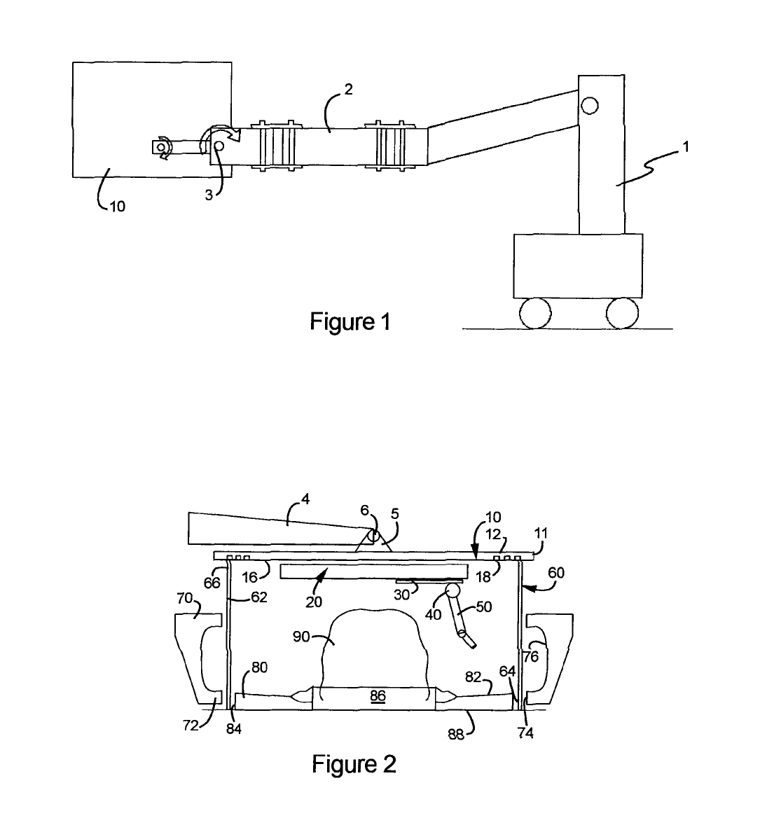

In FIG. 1, a cleaning machine used for cleaning of tire curing sidewall mold comprising a basket (10) and a carriage (1) to move the sidewall mold (80) is shown from the side view schematically. The carriage (1) is equipped with a foldable arm (2). Basket (10) is attached by means of a hinge (3) the foldable arm (2) from a free end thereof.

In FIG. 2, the basket (10) is in connection with a handle (5) of the pivot (6) through free end of a support arm (4) connected through the carriage (1). The basket (10) is provided at a reverse position is enclosing a sidewall mold (80) disposed at the ground facing towards the upper side and surrounded by a segment mold (70) from lateral side.

The basket (10) comprises a tubular base plate (12) and an insulation hood (60) at an inner portion of the basket is elevated through a vicinity of peripheral edges of the base plate (12) in order to form an opening. At a working position, insulation hood (60) is inserted into a gap between radial outer edge (84) of the sidewall mold (80) and the bottom edge (70) of the sidewall mold (70) facing each other, form a closed cell between the basket (10) and sidewall mold (80).

In such a position, a cleaning arm (50), which is fitted into a platform (30) is provided at a radially outer side of a turntable (20) rotatably mounted to the base plate (12) of the basket (10), is secured from its one end with the joint (40).

Angle of the cleaning arm (50) allowed by the joint (40) is configured radially outwardly so that preventing a contact between the telescopic arm (50) and the inner tire (90) extending into the cell passing through an opening (86) provided at the center of the sidewall mold (80), due to a movement inside the cell during the rotation of the turntable (20). Cleaning arm (50) carry out the cleaning process at the sidewall mold (80) along the frontal surface (82) when rotated by the turntable (20).

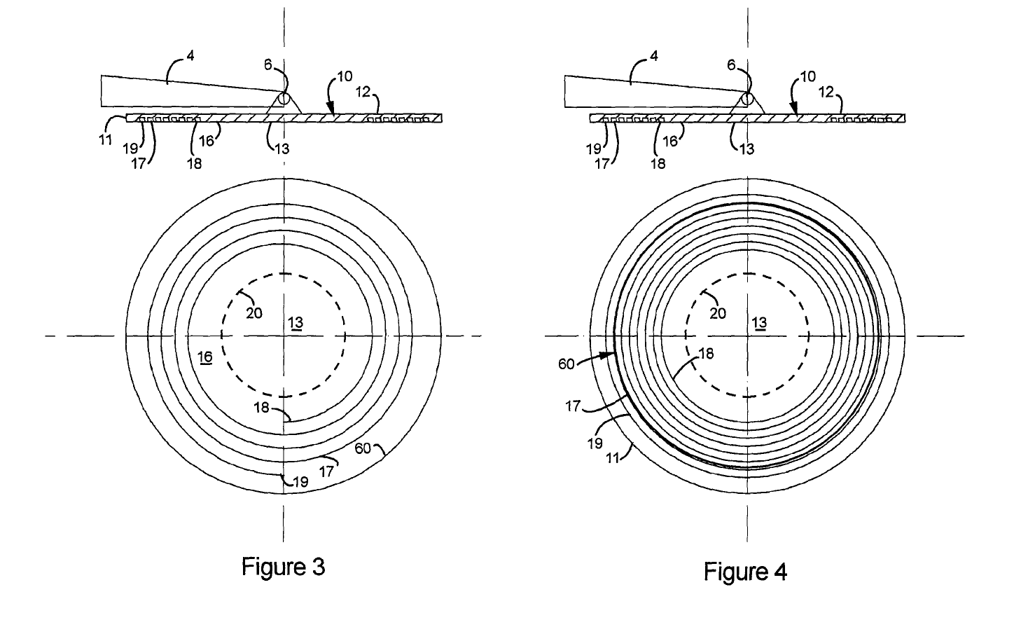

In FIG. 3, an embodiment of the basket (10) of the cleaning assembly subject to the present invention is shown from a cross-section side view and from the front. The base plate (12) of the basket (10) is attached by means of a joint (6) to the end of the support arm (4) which is mounted to the carriage (1). Base plate (12) is in an annular flat form. A spiral adapter support (16) is provided with an outer groove (11) at a vicinity of the periphery of the outer edge (11) of the base plate (12), intermediate recesses (17) coaxial to the outer groove (11) and equally separated with each other and an inner recess (18) inside is positioned at the outer side of the turntable (20). Central region (12) of the annular center of the base plate (12) is in a flat form. Grooves start with the inner groove (18) which is outside the central region (13), radially out of the alignment between base plate (12) and coaxial base (20) and ends with outer groove (19) in a radially expanding manner. This provide an adaptor housing (16) with a radius adjustable from narrow to wide. Inner groove (18) is suitable for being adapted to the radius of the most narrow possible tire mold to be cleaned. At the other hand, outer groove (19) is suitable for being adapted to the widest possible tire mold to be cleaned.

Accordingly, tire curing mold halve cleaning with the same cleaning mechanism is possible for a factory producing a narrow vehicle tire and at the same time a wide tire for a construction equipment or truck: Insulation hood (60) with various diameters is mounted to the base plate (12) in a fast manner via adapter support (16).

In FIG. 4, an alternative base plate (12) for cleaning assembly is shown. Instead of a spiral form, adapter support (16) is rings inside one another with the base plate (12). In such a case, an insulation hood (60) made from a rolled sheet metal can be easily inserted into the respective adapter support (16) ring from an inner edge.

1. A cleaning assembly for cleaning a tire curing mould comprising a turntable (20) mounted on a base plate (12); a cleaning arm (50) extending on the turntable (20) in a movable manner and configured to blast dry ice, and an insulation hood (60) encapsulating the cleaning arm (50) characterized in that the base plate (12) is having an adapter support (16) configured to be gradually widen or narrow for being adapted to the insulation hoods with different diameters on the base plate.

2. A cleaning assembly according to claim 1, wherein inner face of the adapter support (16) is having multiple inner grooves (18) inside one another to hold the insulation hood (60) from one edge from which is inserted into the inner groove (18).

3. A cleaning assembly according to claim 2, wherein the inner grooves (18) are in form of coaxial rings.

4. A cleaning assembly according to claim 2, wherein the inner grooves (18) are in form of a spiral.

5. A cleaning assembly according to claim 2, wherein the adapter support (16) is configured to have an inner groove (18) at a vicinity of outer side of the turntable (20) and an outer groove (19) at a vicinity of outer edge of the base plate (12).

6. A cleaning assembly according to the any one of the preceding claims, wherein insulation hood (60) is in a cylindrical form coaxial with the turntable (20).

7. A cleaning assembly according to the any one of the preceding claims, wherein base plate (12) is pivotally connected to a carriage (1) by means of a foldable arm (2) from outer side.

8. A cleaning assembly according to the any one of the preceding claims, wherein the base plate (12) is a bottom of a cylindrical basket (10).

9. A cleaning method for a tire mold comprising a cleaning assembly according to claim 1, comprising the steps of selection of a insulation hood (60) in accordance with the outer diameter of a tire mold halve; configuration of adapter support (16) to receive outer diameter of the insulation hood (60) then mounting of the insulation hood (60) to the adapter support (16) and cleaning of the mold inside the insulation hood (60) by means of the cleaning arm (50).

10. A cleaning method according to claim 9, comprising the steps of selection as sidewall mold (80) as a tire mold halve to be cleaned and disposing an outer edge (64) of the insulation hood (60) inside a gap defined between the sidewall mold (80) and a neighbouring segment mold (70).
